(19) United States
(12) Patent Application Publication
(10) Pub. No.: US 2009/0108769 A1
(43) Pub. Date: Apr. 30, 2009

(54) LIGHTING DEVICE AND ILLUMINATION APPARATUS

(75) Inventors: Toru Ishikita, Yokosuka-shi (JP); Hajime Osaki, Yokosuka-shi (JP); Noriyuki Kitamura, Hadano-shi (JP); Naoko Iwai, Yokohama-shi (JP); Isao Yamazaki, Shinagawa-ku (JP); Shinji Nogi, Ota-ku (JP); Masatoshi Kumagai, Fujisawa-shi (JP); Masahiko Kamata, Yokohama-shi (JP)

Correspondence Address: DARBY & DARBY P.C., P.O. BOX 770, Church Street Station, New York, NY, 10008-0770, US

(73) Assignee: Toshiba Lighting & Techonology Corporation, Tokyo (JP)

(21) Appl. No.: 12/255,745

(22) Filed: Oct. 22, 2008

(30) Foreign Application Priority Data
Oct. 24, 2007 (JP) 2007-277012
Oct. 24, 2007 (JP) 2007-277014
Jun. 3, 2008 (JP) 2008-145282

(51) Int. Cl. H05B 37/02

(52) U.S. Cl. 315/291

(57) ABSTRACT

The present invention provides a lighting device capable of controlling finely modulated light control without stopping other processing regardless of an operation clock. The light modulation signal generating portion calculates a cycle of a PWM signal based on the lighting state of lamp, which is detected by state detecting portion and a predetermined operation clock. A PWM signal of the cycle calculated by the state detecting portion is generated by the light modulation signal generating portion capable of generating the PWM signal corresponding to the cycle of a non-integral number of times of the operation clock, wherein the cycle of the PWM signal can be continuously and finely varied without stopping other processing regardless of operation clocks, and fine modulated light control is enabled.

### INCORPORATION BY REFERENCE

The present invention claims priority under 35 U.S.C. §119 to Japanese Patent Application Nos. 2007-277012 filed on Oct. 24, 2007, 2007-277014 filed on Oct. 24, 2007, and 2008-145282 filed on Jun. 3, 2008. The content of the applications are incorporated herein by reference in their entirety.

### FIELD OF THE INVENTION

The present invention relates to a lighting device to light a lamp by an inverter circuit and an illumination apparatus including the same.

### BACKGROUND OF THE INVENTION

Generally, a lighting device including an inverter circuit is composed so as to light a lamp at a fixed brightness by controlling the switching cycle of switching means and the duty ratio of switching in accordance with the lighting state of the lamp and power source voltage.

In recent years, in line with the development of various types of digital devices, a lighting device that is digitally controlled in order to enable control of the lighting device from a digitalized peripheral device has increased. In this case, it is common that a control device to control a drive of an inverter circuit is digitalized, wherein by thus digitalizing a control device, desired control characteristics can be easily obtained, and quick response control can be expected.

A digital signal processor (DSP) that is a digitalized control device generates a PWM signal supplied to the inverter circuit by a digital calculation process. At the time of such a digital calculation process, by detecting a power source voltage and a lighting state of a lamp, generating the PWM signal in accordance with the detection and inputting it into the inverter circuit, the lamp is lit in a stable state by controlling, for example, the lighting frequency of the lamp and the on-duty of the output voltage.

However, where the PWM signal is generated by such a digital calculation process, there is a problem that the cycle of the PWM signal depends on an operation clock of the digital signal processor. That is, where the operation clock of the digital signal processor is comparatively small, in other words, in a case of low-rate controlling means, it is not easy to carry out fine frequency control.

On the other hand, if the operation clock of the digital signal processor is improved, another problem will arise, for example, that the consumption power will increase, and related costs will increase.

Therefore, as described in, for example, Japanese Published Unexamined Patent Application No. 2000-150180, such a type has been known, in which the cycle of the PWM signal is adjusted during stop by stopping the digital signal processor by an interrupt processing for a predetermined period of time.

However, in the above-described lighting device, there is another problem that, since the digital signal processor is stopped when adjusting the cycle of the PWM signal, no other process can be carried out by the digital signal processor during this adjustment.

The present invention has been developed in view of such points, and it is therefore an object of the present invention to provide a lighting device capable of finely modulating light without stopping other processes regardless of an operation clock and an illumination apparatus including the same.

### SUMMARY OF THE INVENTION

A lighting device according to the present invention includes: an inverter circuit for causing a lamp to be lit by converting direct current voltage to high frequency voltage and outputting the same; state detecting means for detecting a lighting state of the lamp; calculating means for calculating the cycle of PWM signals that actuates the inverter circuit based on at least the lighting state of the lamp detected by the state detecting means and a predetermined operation clock; signal generating means, which is composed so as to generate PWM signals corresponding to a cycle of a non-integral number of times of the predetermined operation clock, for generating PWM signals of a cycle calculated by the calculating means; and means for controlling and driving the inverter circuit in accordance with the PWM signals generated by the signal generating means.

It is preferred that the lamp is a low pressure mercury discharge lamp such as a fluorescent lamp, or an LED. However, the lamp is not limited thereto.

For example, a half-bridge type inverter circuit equipped with a pair of switching elements may be used as the inverter circuit. However, it is not limited thereto.

The state detecting means is capable of detecting a lighting state of a lamp by detecting, for example, the current and voltage of the lamp.

The calculating means is an A/D converter for obtaining a cycle of PWM signals by converting, for example, the lamp current and lamp voltage, which are analog signals of the lamp to discrete digital signals.

The signal generating means may be, for example, a microprocessor unit (arithmetic element) such as, a microcomputer, and is a digital portion that operates at a timing corresponding to an operation clock generated by an operation clock generating portion and generates PWM signals, corresponding to the state of a lamp, of a cycle of a non-integral number of times of the operation clock.

The controlling means is, for example, a high side driver connected to a switching element of the inverter circuit.

And, the cycle of PWM signals is calculated based on a lighting state of a lamp, which is detected by the state detecting means, and a predetermined operation clock, and the PWM signals of the calculated cycle are generated by the signal generating means capable of generating PWM signals corresponding to the cycle of a non-integral number of times of a predetermined operation clock, wherein the cycle of the PWM signals can be continuously and finely varied without stopping the other processes regardless of the operation clock, and fine modulated light control is enabled.

Further, in the lighting device according to the present invention, the signal generating means alternately generates the first edge operating corresponding to either one of a rise or fall of a predetermined operation clock and the second edge output corresponding to either one of an interval between a rise or fall or an interval between a fall or rise of the predetermined operation clock.

One of the first edge and the second edge is a rise edge, and the other thereof is a fall edge.

And, since the signal generating means alternately generates the first edge operating corresponding to either one of the rise or fall of a predetermined operation clock and the second edge output corresponding to either one of the interval between the rise or fall or the interval between the fall or rise of the predetermined operation clock, the cycle of the PWM signal can be controlled between the second edges, and the duty ratio of the PWM signal can be set to an optional fixed value between the first edges.

Also, in the lighting device according to the present invention, the inverter circuit is provided with a switching element, converts a direct current voltage to high frequency voltage by a switching operation of the switching element corresponding to the cycle of the PWM signal generated by the signal generating means, and lights a lamp so that the range of fluctuation of the output voltage corresponding to the cycle minimum resolution width of the PWM signal becomes smaller than 2V.

The cycle minimum resolution width means the width from the rise to fall of the minimum pulse of the PWM signal.

And, since the inverter circuit lights a discharge lamp so that the range of fluctuation of output voltage corresponding to the cycle minimum resolution width of the PWM signal becomes smaller than 2V, stabilized modulation can be carried out even for a discharge lamp having a comparatively high output voltage.

In addition, in the lighting device according to the present invention, the signal generating means feedback-controls the inverter circuit by setting a predetermined target value based on a lighting state of the lamp, which is detected by the state detecting means.

And, by feedback-controlling the inverter circuit by setting a predetermined target value of the signal generating means based on a lighting state of the discharge lamp, which is detected by the state detecting means, the inverter circuit can be efficiently driven corresponding to the lighting state of the discharge lamp.

Further, in the lighting device according to the present invention, the signal generating means is composed so that the cycle of the PWM signal is set to 20 μsec or less, and the cycle of the feedback control of the inverter circuit is set to 100 μsec or less.

And, by setting the cycle of the PWM signal to 20 μsec or less and the cycle of feedback control of the inverter circuit to 100 μsec, the response of the inverter circuit can be further improved.

Still further, in the lighting device according to the present invention, the feedback control of the inverter circuit by the signal generating means is carried out in every cycle.

And, by carrying out the feedback control of the inverter circuit by the signal generating means in every cycle, the response of the inverter circuit can be further improved.

Also, an illumination apparatus according to the present invention includes: an apparatus body to which a lamp is attached; and any one of the lighting devices for controlling lighting of the lamp.

The illumination apparatus may be intended for outdoor illumination, indoor illumination, general illumination and display and the shape thereof may be of any type. Also, the lighting device may be integral with or separate from the illumination apparatus.

And, by providing any one of the above-described lighting devices, respective effects can be brought about.

### BRIEF DESCRIPTION OF THE DRAWINGS

FIG. 1 is a circuit diagram of a lighting device according to one embodiment of the present invention.

FIG. 2 is a bottom view in which a part of an illumination apparatus including the lighting device is shown with a section.

FIG. 3(a) is a timing chart showing the relationship between operation clocks of the same lighting device and the PWM signals, FIG. 3(b) is a schematic view showing a part of the timing chart of FIG. 3(a) in enlargement.

FIG. 4 is a timing chart showing operations of the power source portion of the lighting device.

FIG. 5 is a graph showing the relationship between an operation cycle and lamp voltage of an inverter circuit of a general lighting device.

FIG. 6 is a table showing differentials of lamp voltage per output resolution of the same lighting device.

FIG. 7 is a graph corresponding to respective minimum resolutions in the table of FIG. 6.

### DETAILED DESCRIPTION OF THE INVENTION

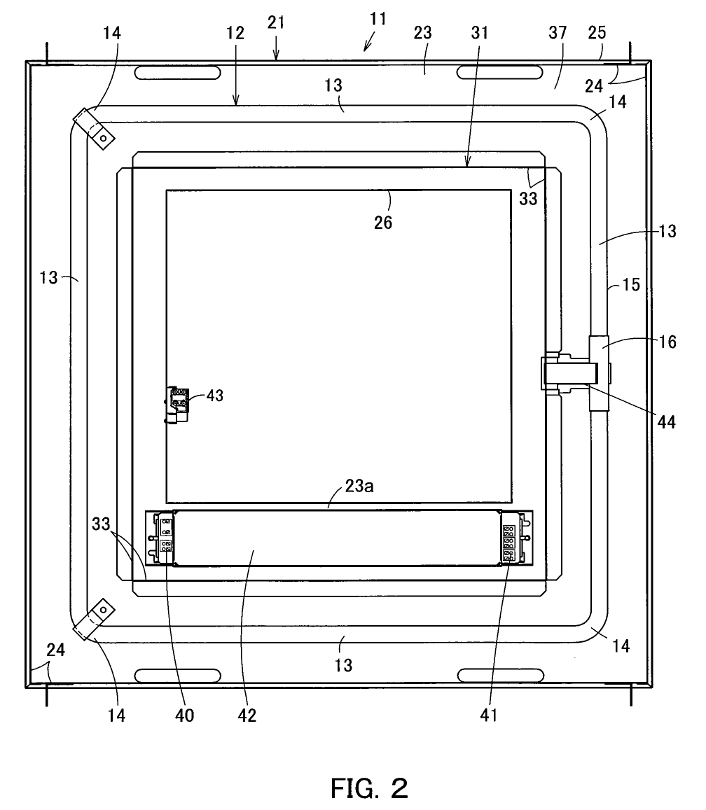

As shown in FIG. 2, a ceiling built-in type illumination apparatus 11 as an illumination apparatus is installed in a system ceiling in which, for example, T-bars are assembled in the form of a grid, and a continuous quadrilateral (continuous square) lamp 12 as a lamp (discharge lamp) that is a light source as a load, that is, a continuous polygonal lamp is used. The lamp 12 has a tubular diameter of, for example, 15 mm through 18 mm, and is provided with a light emitting tube 15, which is formed to be continuously quadrilateral, including four rectilinear sides 13 and four corner portions 14 to connect the ends of the four sides 13 roughly at a right angle, and a ferrule 16 for connecting both ends of the light-emitting tube 15 at the middle part of one side of the light-emitting tube 15 and having a temperature-reduced part formed in the vicinity thereof, and connection pins (not illustrated) connected to electrodes (not illustrated), which are provided at both ends of the light-emitting tube 15 on the inner circumferential side of the ferrule 16, are provided so as to protrude therefrom.

And, the ceiling built-in type illumination apparatus 11 has an apparatus body 21, and the apparatus body 21 is formed to be like a square box with the underside open. The apparatus body 21 is provided with the quadrilateral top plate portion 23, side plate portions 24 bent downward from the circumferential edge portion of the top plate portion 23 and frame portions 25 bent to be roughly L-shaped at the circumference of the lower end of the side plate portions 24. The outer dimensions of the frame portion 25 of the apparatus body 21 are formed to be smaller than the inner dimensions of a recessed opening entirely surrounded by T-bars of the system ceiling.

A quadrilateral opening portion 26 is opened and formed at the middle part of the top plate portion 23, and on the underside of the opening portion 26, an attachment member 31 attached to a ceiling facility (hereinafter merely called an “attachment member”) is detachably attached to the underside of the top plate portion 23 by means of screws.

A continuous quadrilateral lamp accommodation portion 37 with the underside open is formed among the ceiling plate portion 23 of the apparatus body 21, the side plate portions 24 thereof, and the side portions 33 of the attachment member 31, and a lamp 12 is accommodated and disposed in the lamp accommodation portion 37.

In addition, a discharge lamp lighting device 42 (hereinafter called a “lighting device 42”) that is a lighting device operating as a load controlling device in which the power input side 40 is disposed at one end along the edge part of the opening portion 26 and the lamp output side 41 is disposed at the other end thereof is attached to the lighting device attaching portion 23a that is the edge part of one side of the opening 26 on the underside of the top plate portion 23 of the apparatus body 21, a power source terminal rack 43 is attached to the edge part of a side crossing one side of the opening portion 26 where the lighting device 42 is attached at the power source input side 40 of the lighting device 42, the ferrule 16 of the lamp 12 is connected to the edge part of a side opposed to the side of the opening portion 26 where the power source terminal rack 43 is attached at the lamp output side 41 of the lighting device 42, and a lamp socket 44 that is concurrently used as a lamp holder for detachably retaining the ferrule 16 of the lamp 12 is attached thereto. The lighting device 42 and the power source terminal rack 43 are disposed inside the attachment member 31 and are covered along with the opening portion 26.

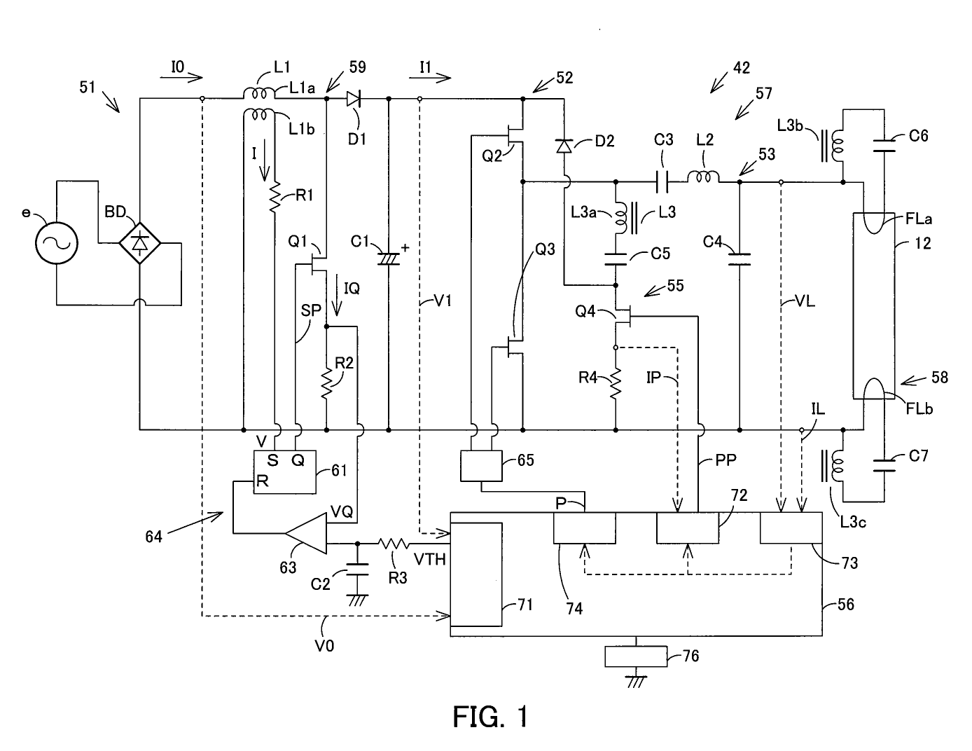

And, in the lighting device 42, as shown in FIG. 1, an inverter circuit 52 is connected to a power source portion 51 that rectifies and smoothens the commercial alternate current power source “e,” and filaments FLa and FLb of the lamp 12 are connected to the output end of the inverter circuit 52 via a resonance circuit 53. Also, a preheating circuit 55 of the filaments FLa and FLb of the lamp 12 is connected to the connection part between the inverter circuit 52 and the resonance circuit 53. Further, a digital signal processor 56 (hereinafter called a “DSP 56”) that is circuit controlling means as the control device is connected to the power source portion 51, the inverter circuit 52 and the preheating circuit 55. And, a lighting circuit 57 operating as an operation circuit is composed of the commercial alternate current power source “e,” power source portion 51, inverter circuit 52, resonance circuit 53, preheating circuit 55 and DSP 56, etc., and the main circuit 58 is composed by connecting the lighting circuit 57 and the lamp 12 to each other.

The power source portion 51 is a voltage boosting chopper power source which aligns the phases of the input current I0 and the input voltage V0 with each other, and is provided with a power factor correction (PFC) of a so-called critical field (non-continuous mode), wherein a bridge diode BD operating as an all-wave rectification portion is connected to the commercial alternate current power source “e,” and the voltage boosting chopper circuit 59 is connected to the output side of the bridge diode BD. In the voltage boosting chopper circuit 59, a series circuit of a chopper choke L1, which is a transformer for boosting voltage, and an anti-blocking diode D1 is connected to the output side of the bridge diode BD between the same and the inverter circuit 52, and a field effect transistor (FET) Q1, which is the first switching element operating as a switching element, that is, a switching element for chopping, is connected in parallel to the connection point between the chopper choke L1 and the anode of the diode D1. Further, an electrolytic capacitor C1, which is a capacitor for smoothening, is connected in parallel to the connection point between the cathode of the diode D1 and the inverter circuit 52.

The chopper choke L1 has a primary winding L1a and a secondary winding L1b, the primary winding L1a is connected between the output side of the bridge diode BD and the anode of the diode D1. At the same time, one end side of the secondary winding L1b is connected to a ground, and the other end side thereof is connected to a setting terminal of a flip flop 61 being a sequential circuit operating as a control signal generating portion via a resistor R1 for detection. Therefore, choke voltage V produced by the choke current I from the secondary winding L1b of the chopper choke L1 at the resistor R1 is input to the setting terminal of the flip flop 61.

In the field effect transistor Q1, the drain terminal is connected to the connection point between the chopper choke L1 and the anode of the diode D1, and the source terminal is connected to a ground via the resistor R2. And, the gate terminal being a control terminal is connected to the output terminal of the flip flop 61.

Herein, the flip flop 61 is a so-called RS type, in which the output terminal of a comparator operating as an operational amplifier, that is, an analog comparator 63 is connected to a resetting terminal. In the analog comparator 63, one input terminal is connected to the connection point between the drain terminal of the field effect transistor Q1 and the resistor R2, voltage VQ produced at the resistor R2 by a switching current IQ of the field effect transistor Q1 is input therein, another input terminal is connected to the DSP 56 via the resistor R3, and the connection point with the resistor R3 is connected to the ground via the capacitor C2.

And, a chopping control portion 64 being voltage boosting chopper circuit controlling means operating as a switching pulse generation circuit, which controls operations of the voltage boosting chopper circuit 59 based on the zero current phase of the choke current I and the switching current IQ, is composed of the flip flop 61 and the analog comparator 63.

In addition, the inverter circuit 52 is a so-called half-bridge type in which field effect transistors Q2 and Q3 being an inverter switching element operating as the second switching element are connected in series to the power source portion 51.

Since the gate terminal being a control terminal is connected to the DSP 56 via a high-side driver 65 operating as the control means, the field effect transistors Q2 and Q3 are controlled for ON and OFF by signals supplied from the high-side driver 65.

The high-side driver 65 alternately turns on and off (switch-driving) the field effect transistors Q2 and Q3 at a frequency of several tens of kHz through 200 kHz, in the present embodiment, for example, 50 kHz or more (cycle of 20 μsec or less) in accordance with the PWM signals P for light modulation, which are supplied from the DSP 56, wherein the high-side driver 65 generates a predetermined high frequency alternate current between the drain and the source of the field effect transistor Q3.

In the resonance circuit 53, the resonance capacity C4 is connected in parallel between both ends of the field effect transistor Q3 with a capacitor C3, which blocks direct current components, and resonance winding (resonance inductor) L2 intervening therebetween in series.

The preheating circuit 55 is provided with a preheating transistor L3, a capacitor C5, a field effect transistor Q4 operating as a preheating switching element, and a series circuit of resistor R4 for current detection, and a diode D2 is connected between the connection point of the capacitor C5 to the field effect transistor Q4 and the source terminal of the field effect transistor Q2.

The preheating transistor L3 has the primary winding L3a, the first secondary winding L3b and the second secondary winding L3c disposed so as to be opposed to each other. The primary winding L3a is connected between the connection point of the field effect transistors Q2, Q3 and the resonance capacitor C4, and the respective secondary windings L3b and L3c are connected to the filaments FLa and FLb of the lamp 12 via the capacitors C6 and C7, respectively.

The field effect transistor Q4 has the gate terminal being a control terminal connected to the DSP 56, and is controlled for switching by the preheating PWM signals supplied from the DSP 56.

And, the DSP 56 is an MPU (arithmetic element) such as a so-called microcomputer, which carries out digital signal processing, and is internally and integrally provided with a voltage setting portion 71 being a reference voltage setting portion operating as a reference waveform setting portion connected to the input terminal of the analog comparator 63, a preheating circuit control portion 72 to control switching of the field effect transistor Q4 of the preheating circuit 55, a state detecting portion 73 having a function of the state detecting means that detects an operating state (an operating state of the main circuit 58) of the lighting circuit 57 and lamp 12 by detecting any one of the discharge current, that is, the lamp current IL and the discharge voltage, that is, the lamp voltage VL and a light modulation signal generating portion 74 being an inverter circuit control portion operating as signal generating means that generates PWM signals P for operation control of the field effect transistors Q2 and Q3 of the inverter circuit 52 based on the operating state detected by the state detecting portion 73, and is further provided with a ROM and a RAM, which are memory means (not illustrated), and I/O ports being an interface. Also, respective parts of the DSP 56 operate at a timing dependent on the operation clocks CLK generated by the clock generating portion 76 operating as the operation clock generating means.

In addition, the DSP 56 being provided with the voltage setting portion 71, preheating circuit control portion 72 and light modulation signal generating portion 74 means that these components commonly share a software processing portion in the DSP 56.

The voltage setting portion 71 is a software portion having a function of power source voltage detecting means that detects either one of the input voltage V0 and output voltage V1 of the power source portion 51, and sets a reference voltage VTH being the PWM signal being a reference voltage to compare the analog comparator 63 based on either one of the voltage V0 or V1 detected above.

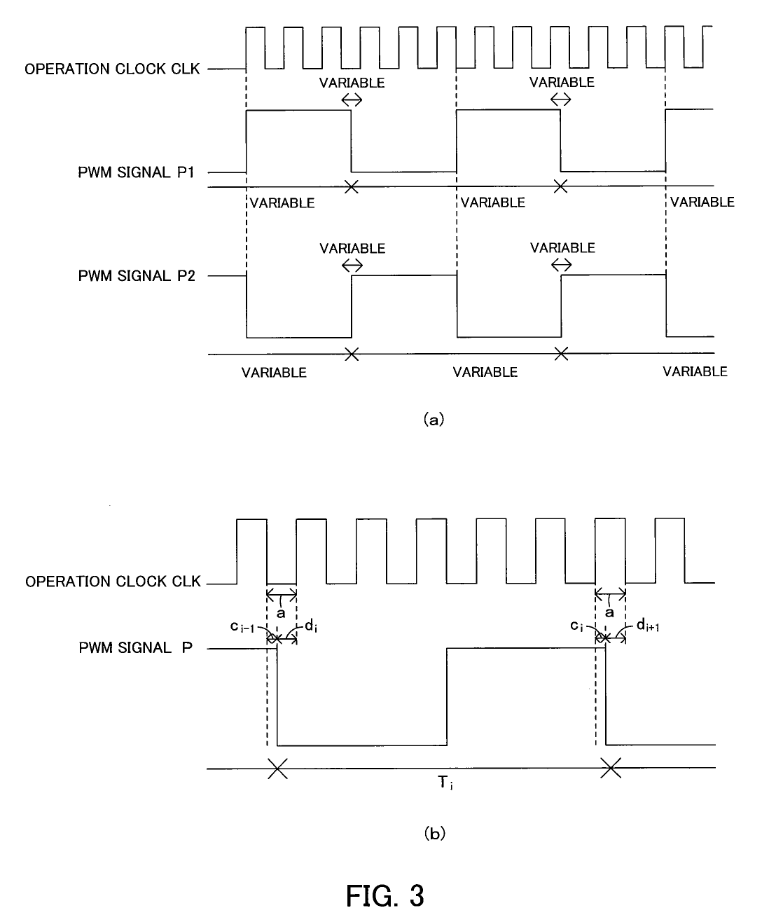

In detail, in the present embodiment, the reference voltage VTH is set, as shown in FIG. 1 and FIG. 3(a), so that a switching pulse SP of the field effect transistor Q1 being the control signal to feedback-control the output voltage V1 so as for the output voltage V1 to approach a predetermined target value by a rectified power source voltage waveform which becomes a reference waveform SW, that is, the PWM control signal so as for the reference voltage VTH to be turned off by a difference between the voltage VQ input into the analog comparator 63 and the reference voltage VTH. Also, the reference waveform SW can be varied, corresponding to, for example, at least either one of the output voltage V1 (output current I1) from the inverter circuit 52 and the power source voltage.

In other words, the lighting device 42 generates the reference voltage VTH for switching to control PFC of the power source portion 51 by the DSP 56, and generates the switching pulse SP for switching the field effect transistor Q1 by the chopping control portion 64 composed of hardware such as the flip flop 61, the analog comparator 63, etc.

The preheating circuit control portion 72 is a software portion having a function of the preheating current detecting means to detect the preheating current IP of the preheating circuit 55, sets the optimal preheating condition, that is, the target value so as to follow a change in at least either one of the lamp current IL detected by the state detecting portion 73 or the lamp current VL while monitoring the preheating current IP of the preheating circuit 55, and generates a preheating PWM signal PP to be supplied to the gate terminal of the field effect transistor Q4 of the preheating circuit 55 so as for the preheating current IP to approach the target value. Also, the preheating circuit control portion 72 may set the target value by following, for example, a change in the lamp power, which is a product of the lamp current IL by the lamp voltage VL, or a change in the ambient temperature. Also, it is preferable that an upper limit, which is set by an energy quantity so that no problem occurs at the end of the service life of, for example, the filaments FLa and FLb, is provided for the target value.

The state detecting portion 73 has a function of an A/D converter for converting either one of the lamp current IL or lamp voltage VL, which is an analog signal, to digital frequency data corresponding to the lamp current IL and lamp voltage VL, and outputs at least either one of the analog-digitally converted lamp current IL or lamp voltage VL to the preheating circuit control portion 72 or the light modulation signal generating portion 74. The timing of detecting the lamp current IL or the lamp voltage VL by the state detecting portion 73 is determined by timing synchronized with the peak phase of the lamp current IL and lamp voltage VL by at least either an analog signal in the main circuit such as, for example, the power source voltage waveform or both-end voltage of resonance capacitor C4, or predetermined frequency data being a digital signal calculated based on the lamp current IL and lamp voltage VL detected by the state detecting portion 73. In the present embodiment, for example, since the state detecting portion 73 has a function of an A/D converter, the timing of detecting the lamp current IL or lamp voltage VL is determined based on predetermined frequency data being a digital signal calculated based on the lamp current IL and lamp voltage VL.

And, the light modulation signal generating portion 74 is a software portion that has a function of calculating means for calculating the cycle of the PWM signal P based on the lighting state and operation clock CLK based on the lighting state of the lamp 12, which is detected by the state detecting portion 73, that is, at least either one of the lamp current IL or the lamp voltage VL and generates the PWM signal P of the calculated cycle.

Herein, the PWM signal P generated by the light modulation signal generating portion 74 sets the duty of the PWM signal P between the first edges and sets the cycle of the PWM signal P between the second edges by alternately outputting the first edge, at which the duty ratio of the PWM signal is dependent on an operation clock CLK, that is, which operates corresponding to either one of the rise or fall of the operation clock CLK, in other words, of an integral-number of times of the operation clock CLK, and the second edge, at which the duty ratio is not dependent on the operation clock CLK, that is, which corresponds to either one of the interval between the rise and fall of the operation clock CLK or the interval between the fall and rise of the operation clock CLK, in other words, of a non-integral number of times.

In detail, as shown in FIG. 3(a) and FIG. 3(b), the light modulation signal generating portion 74 carries out interrupt processing at a timing corresponding to a rise edge of the operation clock CLK by dividing the cycle Ti of the calculated PWM signal P by the operation clock CLK (width a) (Tᵢ=a·nᵢ+bᵢ, nᵢ, where “i” is a natural number, a>bᵢ), and generates the second edge of the PWM signal P with a delay from the rise edge of the operation clock CLK only by a delay cᵢ₋₁ from the rise of the operation clock CLK of a fraction bᵢ₋₁ generated by division (Tᵢ₋₁=a·nᵢ₋₁+bᵢ₋₁, nᵢ₋₁ is a natural number) in the above cycle Tᵢ₋₁, wherein a differential between the fraction bᵢ generated by the division of the current cycle Tᵢ and the fraction dᵢ generated between the second edge and the fall edge of the operation clock CLK by the delay cᵢ₋₁ becomes a delay cᵢ from the rise of the operation clock CLK in the next cycle Tᵢ₊₁. That is, bᵢ−dᵢ=cᵢ, cᵢ₋₁+dᵢ=a. The first edge may be obtained by the duty of the PWM signal P.

Also, a slight dead zone is formed, although not illustrated, between the edge of the PWM signal P1 for the field effect transistor Q2 and the edge of the PWM signal P2 for the field effect transistor Q3. In addition, although the first edge of the PWM signal P1 (the PWM signal P2) is a fall edge (a fall edge), and the second edge thereof is a rise edge (a rise edge), these are similar thereto for the opposite.

That is, the light modulation signal generating portion 74 has a function of a duty setting portion, which sets, with respect to the timing (the pulse width of the PWM signal P) for inverting the edge of the pulse of the PWM signal P, the delay cᵢ based on the fraction dᵢ generated in regard to the edge of the operation clock CLK by the duty (on-duty or off-duty) of the PWM cycle P of the previous cycle, so that the duty ratio of the PWM cycle P of the current cycle becomes roughly fixed. The cycle control of the PWM signal P is carried out in every cycle or once in a predetermined number of cycles, for example, once every several cycles with cycles of 100 μsec.

Therefore, in the present embodiment, in the light modulation signal generating portion 74, the timing of the second edge of the PWM signal P can be varied without being dependent upon the operation clock CLK although the timing of the first edge of the PWM signal P is dependent on the operation clock CLK, the on-duty (off-duty) is varied at the timing independent from the operation clock CLK, and the cycle of the PWM signal P can be controlled (PFM-controlled) so as to correspond to an integral number of times of the operation clock CLK and a non-integral number of times thereof. In other words, the light modulation signal generating portion 74 is a converting means for converting the duty change of the PWM signal P to a change in cycle (a change in frequency).

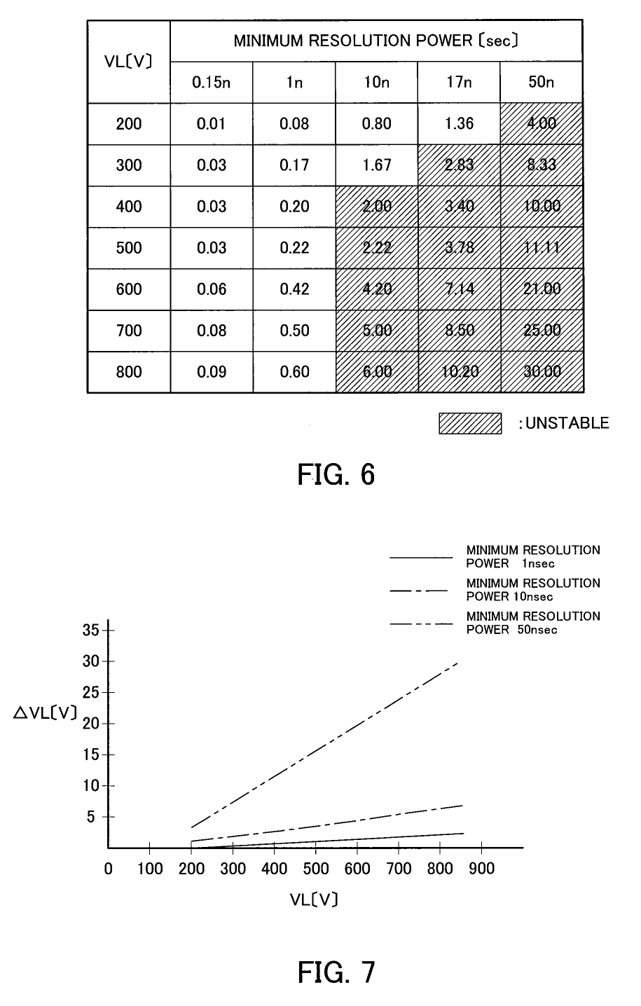

Herein, in a lighting device 42 using a resonance effect by the resonance circuit 53, as shown in FIG. 5, a change in the lamp voltage VL for the cycle of the PWM signal P (switching cycles of the field effect transistors Q2 and Q3) is increased. Therefore, since the inverter circuit 52 is digitally controlled, the output is made stepwise, and stabilized lighting is not easily made. Further, if the control cycle is slow, and the feedback control is carried out, stabilized lighting is not easy as well. In detail, as shown in the table of FIG. 6 showing a case where, for example, the inductance of the resonance winding L2 is 1.4 mH and the capacitance of the resonance capacitor C4 is 3300 pF, and in FIG. 7, where the fluctuation range ΔVL of the lamp voltage VL corresponding to the cycle minimum resolution width (minimum resolution power) of PWM signal P is 2V or more, the lighting state of the lamp 12 becomes unstable (theme shed portion in the table of FIG. 6), for example, the lamp 12 flickers. Therefore, in the present embodiment, the inverter circuit 52 is set so that the fluctuation range ΔVL of the lamp voltage VL corresponding to the cycle minimum resolution width of the PWM signal P becomes smaller than 2V (ΔVL<2[V]).

Further, the cycle minimum resolution width means the width from the rise edge of the minimum pulse of PWM signal P to the fall edge thereof.

Various types of programs carried out by respective parts of the DSP 56, for example, the voltage setting portion 71, the preheating circuit control portion 72 and the light modulation signal generating portion 74, are stored in the ROM in advance.

Various types of digital values detected by the state detecting portion 73 are stored in areas assigned thereto in the RAM.

And, the lighting device 42 generates a switching pulse SP by operation of the flip flop 61 in the power source portion 51, causes the field effect transistor Q1 to carry out a switching operation, and improves the power factor by aligning the phases of the input voltage V0 and input current I0 with each other.

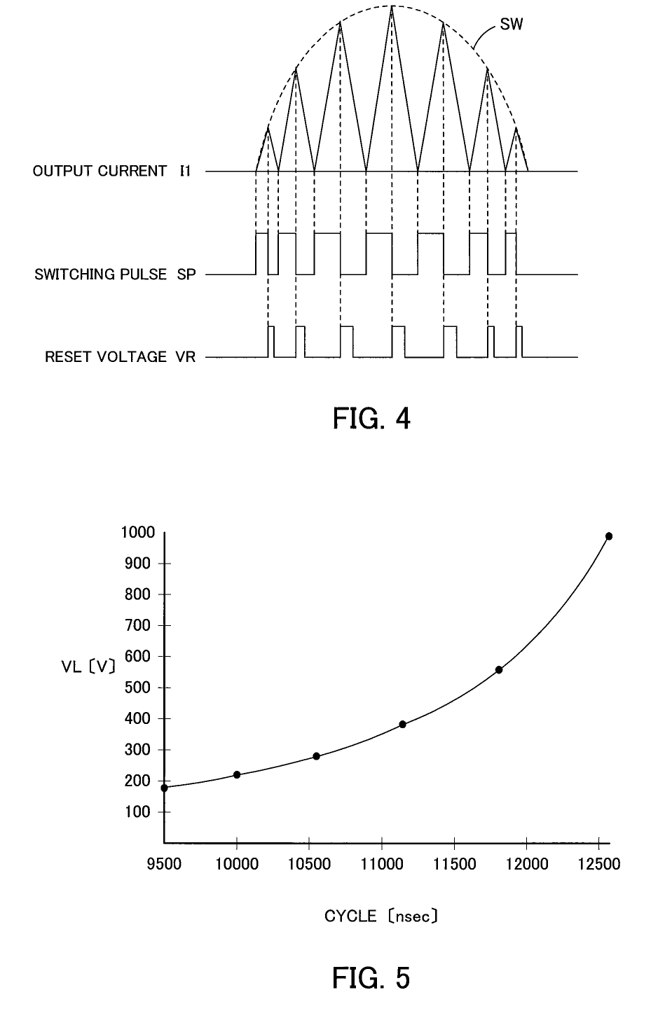

In detail, as shown in FIG. 1 and FIG. 4, if the field effect transistor Q1 is turned on by a starting circuit or the like (not illustrated), a linearly increasing current flows to the chopper choke L1 (diode D1), wherein a choke current I flows to the secondary winding L1b of the chopper choke L1, and electromagnetic energy is accumulated in the chopper choke L1. Simultaneously, as voltage VQ (≧reference voltage VTH) produced by the resistor R2 by the switching current IQ by turning-on of the field effect transistor Q1 is input into the analog comparator 63, reset voltage VR (=voltage VQ) is input from the analog comparator 63 to the reset terminal of the flip flop 61, and an OFF switching pulse SP is supplied from the output terminal of the flip flop 61 to the gate terminal of the field effect transistor Q1, wherein the field effect transistor Q1 is turned off. Therefore, the electromagnetic energy accumulated in the chopper choke L1 is emitted, and a linearly decreasing current flows to the chopper choke L1 (diode D1).

By repeating the operation, output current I1 is formed with the reference waveform SW, which is a waveform of input voltage V0, that is, a full-wave rectified sine waveform, used as an envelope curve.

The output voltage V1 generated by the power source portion 51 is converted to high frequency alternate current voltage by turning on and off the field effect transistors Q2 and Q3 of the inverter circuit 52 at a predetermined frequency such as 50 kHz, and at a predetermined on-duty.

With the high frequency alternate current voltage, the resonance circuit 53 resonates to cause a resonance current to flow, a preheating current IP flows to respective secondary windings L3b and L3c of the preheating transformer L3 of the preheating circuit 55 by which the field effect transistor Q4 is subjected to a switching operation, respectively, by a preheating PWM signal PP of a predetermined cycle, which is generated by the preheating circuit control portion 72, and the filaments FLa and FLb of the lamp 12 are preheated.

And, predetermined starting voltage is applied between the filaments FLa and FLb by preheating of the filaments FLa and FLb to cause the lamp 12 to be lit (started), wherein the lamp 12 is constantly lit.

At this time, in the lighting device 42, feedback control is carried out based on at least either one of the lamp current IL or lamp voltage VL detected by the state detecting portion 73 so that the lamp current IL, lamp voltage VL or the lamp power, which is the product thereof, becomes a predetermined target value.

Where the lamp 12 lit as described above is modulated, the drive frequency of the inverter circuit 52 is varied by inputting the PWM signal P from the light modulation signal generating portion 74 of the DSP 56 into the high-side driver 65 of the lighting device 42. By increasing or decreasing the drive frequency of the inverter circuit 52, the high frequency power from the inverter circuit 52 is suppressed or increased, wherein since the lamp current IL is suppressed or increased, the lamp 12 is modulated.

The drive frequency of the inverter circuit 52, that is, the cycle of the PWM signal P is varied without being dependent on the operation clock CLK by inverting, based on either one of the on-duty or off-duty of the PWM signal P of the previous cycle, the fall edge of the PWM signal P at the timing independent from the operation clock CLK set in the light modulation signal generating portion 74 so that the duty ratio of the PWM signal P of the next cycle becomes constant after the PWM signal P having a cycle dependent on the operation clock CLK generated by the clock generating portion 76 is generated based on at least either one of the lamp current IL or lamp voltage VL detected by the state detecting portion 73 in the light modulation signal generating portion 74.

The frequency control of the PWM signal P is carried out in every cycle or within predetermined cycles, for example, once every several cycles within 100 μsec, and the lighting state of the lamp 12 is instantaneously reflected in the cycle of the PWM signal P.

Herein, the inverter circuit 52 is controlled so that the fluctuation range ΔVL of the lamp voltage VL corresponding to the cycle minimum resolution width of the PWM signal P is made smaller than 2V.

Also, in the preheating circuit 55, the preheating amount during lighting, which may change in accordance with the type of the lamp 12 and unevenness in the production process thereof is optimized by causing the field effect transistor Q4 to be subjected to the switching operation by the preheating PWM signal PP generated so that the preheating current IP is drawn near the target value set by the preheating circuit control portion 72 so as to follow the lamp current IL detected by the state detecting portion 73, lamp voltage VL, lamp power or a change in the ambient temperature.

As described above, the light modulation signal generating portion 74 calculates the cycle of the PWM signal P based on a lighting state of the lamp 12, which is detected by the state detecting portion 73, a predetermined operation clock CLK and a light modulation signal, and the PWM signal P of the calculated cycle is generated by the light modulation signal generating portion 74 capable of generating the PWM signal corresponding to the cycle of a non-integral number of times of a predetermined operation clock CLK, whereby it is possible to continuously and finely vary the cycle of the PWM signal P regardless of the operation clock without stopping other processes and fine modulated light control is enabled.

In detail, since the light modulation signal generating portion 74 alternately generates the first edge operating corresponding to either one of the rise or fall of a predetermined operation clock CLK and the second edge output corresponding to either one of the interval between the rise and fall of the predetermined operation clock CLK or the interval between the fall and rise thereof, the cycle of the PWM signal P can be controlled between the second edges, and the duty ratio of the PWM signal P can be set to an optional fixed value between the first edges.

That is, since the operation clock CLK is comparatively small, in other words, a DSP 56 that operates at a low rate and is inexpensive may be used, the production cost of the lighting device 42 can be reduced.

In particular, since the lighting device 42 according to the present embodiment uses a resonance circuit 53, it may be provided with a light modulation signal generating portion 74 capable of generating a PWM signal P that can cope with a cycle of a non-integral number of times as described above because fine frequency (cycle) control becomes important, wherein fine modulated light control is enabled.

Also, the light modulation signal generating portion 74 easily sets the duty of the PWM signal P shorter than the operation clock CLK by setting the duty ratio by inverting the second edge of the PWM signal P at a timing independent from the operation clock CLK.

The light modulation signal generating portion 74 sets the cycle of the PWM signal P at a predetermined timing such as a timing synchronized with the peak phase of the lamp current IL and lamp voltage VL determined based on predetermined frequency data calculated based on at least any signal in the main circuit 58 or the lamp current IL and lamp voltage VL, and sets the lighting frequency of the lamp 12. Therefore, the lighting state of the lamp 12 can be set at an appropriate timing. As a result, lighting of the lamp 12 can be maintained even if the lamp 12 is in an unstable state between turning-off and turning-on, wherein meticulous light modulation is enabled.

In the light modulation signal generating portion 74, the cycle of the PWM signal P is set to 20 μsec or less, and the operation frequency of the inverter circuit 52 is feedback-controlled in a cycle of 100 μsec or less, in detail, in every cycle based on the lighting state of the lamp 12, wherein the response of the inverter circuit 52 is improved.

In addition, conventionally, as for the lighting device, high efficiency in a discharge lamp and the system thereof has been further advanced by a combination of high-frequency lighting using a resonance effect by a resonance circuit. However, as a result, the lamp diameter has been made small, and the lamp voltage has become high. And, by using the resonance effect, a change in the output voltage, that is, the lamp voltage with respect to the cycle (switching cycle of the switching element) of the PWM signal increases. Accordingly, if the inverter circuit is digitally controlled, the output becomes stepwise, and stable lighting is not easy. Further, if the control cycle is slow and feedback control is carried out, stable lighting is not easy as well.

For this reason, by the inverter circuit 52 causing the lamp 12 to be lit so that the fluctuation range ΔVL of the lamp voltage VL corresponding to the cycle minimum resolution width of the PWM signal P becomes smaller than 2V, stable light modulation is enabled even for the lamp 12 the lamp voltage VL of which is relatively high, wherein an energy-saving system can be brought about.

By setting a predetermined target value of the light modulation signal generating portion 74 based on the lighting state of the lamp 12, which is detected by the state detecting portion 73, and feedback-controlling the inverter circuit 52, the inverter circuit 52 can be efficiently driven corresponding to the lighting state of the lamp 12.

Since only the voltage setting portion 71 for setting the reference waveform SW based on the power source voltage waveform is provided to be integral with the DSP 56 along with the light modulation signal generating portion 74, and the chopping control portion 64 for generating switching pulses SP, by which the field effect transistor Q1 is controlled for switching based on the switching current IQ and the choke current I at the secondary winding Lib side of the chopper choke L1, so that the switching current IQ corresponds to the reference waveform SW is composed of hardware separately from the DSP 56, the processing load by the software in the DSP 56 can be reduced in comparison with a case where control signals of the voltage boosting chopper circuit 59 are generated by the DSP, wherein no load is given to the control of the inverter circuit 52, and control of the voltage boosting chopper circuit 59 can be compatible with control of the inverter circuit 52.

In detail, the reference voltage VTH set by the voltage setting portion 71 based on the detected input voltage V0 and output voltage V1 of the voltage boosting chopper circuit is compared with the voltage VQ generated by the switching current IQ of the field effect transistor Q1 by the analog comparator 63, and the switching pulse SP of the field effect transistor Q1 is generated by the flip flop 61 based on the output voltage of the analog comparator 63 and the choke voltage V at the secondary winding L1b side of the chopper choke L1, wherein the processing load by software in the DSP 56 can be reduced, and the switching pulses SP of the field effect transistor Q1 can be easily generated.

And, since the processing load by software in the DSP 56 can be relieved, the processing load by software can be suppressed even if other controls are added to the DSP 56.

By varying the reference waveform SW of the switching current IQ of the field effect transistor Q1 by the voltage setting portion 71 corresponding to the output of the inverter circuit 52 or the power source voltage, the voltage boosting chopper circuit 59 can be driven while relieving the load thereof even in cases where the output of the inverter circuit 52 is low or the power source voltage is low.

The optimal preheating amount of filaments for which the lamps are different from each other and the production processes of the lamps are not even can be set by judging the optimal value of the preheating amount of the filaments FLa and FLb while the lamps 12 are being lit, wherein an excess or a shortage of preheating can be solved, and the lamps 12 are prevented from becoming shorter in service life and early blackening.

And, since the voltage boosting chopper circuit 59, inverter circuit 52 and preheating circuit 55 are digitally controlled by a single DSP 56, the configuration can be simplified in comparison with a case where DSPs exclusive for respective control are provided, and the respective circuits can be easily controlled by reflecting their operating states to each other. Further, useless light can be modulated by combination with, for example, sensors, wherein a further energy-saving effect can be brought about.

In the above-described embodiment, the configuration and control of the power source portion 51 and preheating circuit are not limited to the configuration and control described above.

In addition, the inverter circuit 52 may be configured so that the lamp 12 is started so that the fluctuation range ΔVL of the lamp voltage VL corresponding to the cycle minimum resolution width of the PWM signal P becomes smaller than 2V. In this case, a lamp 12 the lamp voltage VL is relatively high can be started in a stable state.

1. A lighting device comprising:
an inverter circuit causing a lamp to be lit by converting a direct current voltage to high frequency voltage and outputting the same;
a detection device detecting a lighting state of the lamp;
a calculation device calculating the cycle of PWM signals that actuates the inverter circuit based on at least the lighting state detected by the state detecting means and a predetermined operation clock;
signal generating device generating PWM signals corresponding to a cycle of a non-integral number of times of the predetermined operation clock, and generating PWM signals of a cycle calculated by the calculation device; and
a controller controlling and driving the inverter circuit in accordance with the PWM signals generated by the signal generating device.

2. The lighting device according to claim 1, wherein the signal generating device alternately generates a first edge operating corresponding to either one of a rise or fall of a predetermined operation clock and a second edge output corresponding to either one of an interval between a rise and fall of a predetermined operation clock or an interval between a fall or rise thereof.

3. The lighting device according to claim 1, wherein the inverter circuit comprises a switching element, converts direct current voltage to high frequency voltage by a switching operation of the switching element corresponding to the cycle of the PWM signal generated by the signal generating device, and causes a lamp to be lit so that the fluctuation range of output voltage corresponding to the cycle minimum resolution width of the PWM signal.

4. The lighting device according to claim 1, wherein the signal generating device feedback-controls the inverter circuit by setting a predetermined target value based on the lighting state of a lamp, which is detected by a state detecting device.

5. The lighting device according to claim 4, wherein the signal generating device is set so that the cycle of the PWM signal is 20 μsec or less, and the cycle of the feedback control of the inverter circuit is 100 μsec or less.

6. The lighting device according to claim 5, wherein the feedback control of the inverter circuit by the signal generating device is carried out in every cycle.

7. An illumination apparatus including: an apparatus body to which a lamp is attached; and a lighting device according to claim 1, which controls the lighting of a lamp.
